(19) United States
(12) Patent Application Publication
(10) Pub. No.: US 2009/0067610 A1
(43) Pub. Date: Mar. 12, 2009

(54) METHOD AND SYSTEM FOR COMPUTER PROCESSING INFORMATION ON A TELEPHONE COMMUNICATION

(75) Inventors: Jean-Luc Bogros, Bourg La Reine (FR); Laurent Bourretere, Paris (FR)

Correspondence Address: YOUNG & THOMPSON, 209 Madison Street, Suite 500, ALEXANDRIA, VA, 22314, US

(73) Assignee: UPSALE, Paris (FR)

(21) Appl. No.: 12/094,157

(22) PCT Filed: Nov. 17, 2006
(86) PCT No.: PCT/FR2006/002533

§ 371 Date: Sep. 19, 2008

(30) Foreign Application Priority Data
Nov. 18, 2005 (FR) 0511681

(51) Int. Cl. H04M 3/00

(52) U.S. Cl. 379/265.02

(57) ABSTRACT

A method for computer processing information on a telephone communication between a first processing site (SI) and a second subscriber site (S2) consists in generating an URL data item from information items dependent on telephone communication and including the iteration of steps consisting in transmitting a request dependent on the generated data item to a third site (S3) from the first site (S1) via a computer network, in receiving request, in triggering and carrying out integration operations including at least one processing of data items dependent on the transmitted request. The inventive method and system are suitable for all kinds of telephone communications in the case of a campaign of professional or private calls or communications and can be used by a call center, by private or public companies or even in a private place.

The present invention relates to a method and a system for the computerized processing of information relating to a telephone call.

This method aims in particular to integrate a plurality of operations relating to the processing of information involved in a telephone call, in particular of commercial type, and thus to facilitate the work of the parties to a telephone call providing them before, during, and after the telephone conversation with help regarding a plurality of tasks to be carried out.

The field of the invention is the field of telephony and in particular of the integration between telephony and information technology.

The invention applies particularly to Computer Telephony Integration (CTI). This module connecting an internal or external phone call centre with the company computing systems, provides these companies with the ability to use the resources of an information system and the Internet, in order to improve the service provided to customers as well as the productivity of a call centre. This is made possible by the automation of certain tasks and the possibility of setting up a thorough personalization of the relationship with the customer via the information made available by this module. It makes possible, inter alia, to simultaneously display on the screen of the call centre agent the data (customer's form and script of the conversation) as well as the presentation of the call on his telephone set.

A call centre currently comprises:
a database,
a CTI module implementing customer forms, scripts and the survey programs and
an ACD (“Automatic Call Distribution”) module

In the current management of a group of call centres, an advertiser commissions a call campaign which is given to a call centre, in hosted mode and equipped with a virtual ACD. This call centre can transfer all or part of the work to another call centre, and so on. However, a problem arises for the management of the CTI of each call centre, when such a transfer of work occurs.

Each call centre has a CTI module which is unique to itself. It cannot be used to dynamically manage a plurality of call centres. Thus it is not possible to manage a transfer of call work at the level of the CTI.

The document U.S. Pat. No. 6,434,231 refers to “a virtualized CTI connection”, but this virtualization does not appear to able to manage a group of call centres.

The purpose of the invention is to remedy the above-mentioned drawbacks by proposing a method and a system of computerized processing of information relating to a telephone call in a simpler and more flexible way. An objective of the invention is thus to propose a method and a system of virtual CTI making it possible to dynamically process the telephone calls made by several call centres and to make it possible to transfer the work of calls between several call centres.

In order to do this, the invention proposes a method of computerized processing of information relating to a telephone call between a so-called first processing site (S1) and a so-called second correspondent site (S2), comprising
on the one hand,
   generation of an item of data of URL type, starting from information dependant on said telephone call; and
on the other hand, at least one iteration of the following steps:
   transmission, from the said first site (S1) through a computer network to a third site (S3), of a request dependent on the data generated, and
   on reception of this request, triggering and implementing operations termed integration, comprising at least one data processing dependent on the transmitted request.

The method according to the invention proposes a new approach to data processing involving a telephone call. It makes it possible to carry out such a processing from a site, termed processing, which makes it possible to separate the processing of information relating to a telephone call from the site carrying out the call itself and to make it more flexible.

The method according to the invention makes it possible, using a virtual CTI, to manage the data processing relating to telephone calls made in a plurality of call centres and thus to allow transfers of work from one call centre to another, while guaranteeing the computerized processing of the telephone calls forming part of the call workload transferred.

The method according to the invention can advantageously make it possible to guarantee that the various call centres involved in a call campaign can access relevant information in real time and in a more flexible way.

Another advantage of the method according to the invention leads to a secure exchange of information. In fact, the first site S1 can only have access to information relating to the telephone call which it is processing.

The method according to the invention allows great flexibility in the processing of data relating to a telephone call. It makes it possible to make a virtual CTI available to any person and any organization which wants it, using a range of data processing means relating to a telephone call, such as the operations of sending a fax, email, telecopy, etc.

The method according to the invention is, advantageously, easy to implement. It requires only one generation of a data of URL type and the means necessary for this generation, means for telephone call and computing means in order to ensure the various exchanges of information. Moreover, the installation is fast and can be carried out remotely using a communication network, for example of Internet network type.

Communication between the first processing site S1 and the third site S3 can be carried out using a communication of Internet, Minitel or any other computer communication of network type, which can be wired or wireless.

The request transmitted by the first site S1 to the third site S3 is a request composed of a data of URL (Universal Resource Locator) type. It can be data of the www (World Wide Web) or HTTP (Hyper Text Transfer Protocol) or FRP (Fast Reservation Protocol) type, or any other data allowing requests. This data is generated from information dependent on the telephone call. This information can comprise one or more identifier(s) corresponding to the various parties to the call, the data related to the contents of the telephone call, and the data relating to the first site S1.

The data of URL type can be generated by an item of computing equipment of computer or portable computer type, or also by an ACD (Automatic Call Distribution) type. This equipment can be that which is in communication with the third site S3 to which the request was sent. On the other hand, it is possible to provide means of communication between the equipment which carries out the generation of the request and the one carrying out the transmission of the request to the third site S3.

Moreover the third site S3, to which the transmission of the request is made, can be a remote site compared to the first site S1. This makes possible to make the computerized processing of information relating to the telephone call independent of the first and the second site S2, between which the telephone call takes place. This decoupling between the site where the processing of data relating to a telephone call takes place and the site where the processing of the call takes place offers multiple advantages.

On the one hand, in this way, benefits can be derived from the advantages of processing the information relating to a telephone call, without being limited to a geographical localization. As long as there is access to the third site S3 which includes a virtual CTI, it is possible to make a telephone call from any location, while benefiting from a computerized processing of information relating to this call, which will be made by a remote site, which can be the third site S3. Thus, the method according to the invention offers geographic flexibility.

On the other hand, it is possible that the sites processing a telephone call do not have all the means necessary for the complete processing of information relating to the telephone calls which they process. This is especially true for small call centres, composed for example of only one person or a few people. The method according to the invention advantageously makes it possible to make the set of data processing [means] proposed by the distant third site S3 available.

Finally, in this way it is possible to centralize the computerized processing of information relating to a plurality of telephone calls, made in a plurality of calls sites. This allows the telephone calls made in a plurality of call sites to be processed in one site. This makes it possible to avoid investing in data processing means for each site which processes telephone calls, and therefore generates cost savings.

Another advantage of the invention is that the triggering and/or the implementation of integration operations, relating to a telephone call, can be carried out by the third site S3 which receives the request. This makes it possible to concentrate the various integration operations at the third site S3. Thus, communication operations between the third site S3 and a site intended to carry out the triggering and implementation of the integration operations are avoided.

It is however completely possible that these various operations are carried out in remote sites and in this case communication between the various sites will be required. This communication can be a communication of internal, Internet or any other communication of network type, which is wired or wireless.

The integration operations comprise an exchange of information between the first site S1 and the third site S3. These exchanges of information can be carried out before, after, or during the telephone call.

These exchanges of information can advantageously be carried out using a network of Internet type or any other means of exchanging information. The information exchanged can be of any format provided that the format can be used with the means of information exchange and the type of connection used to perform these exchanges. The information exchanged can be, for example, in a PHP, HTML, JAVA application, JAVAScript format or script-type formats.

Moreover, the exchanges of information can be carried out at the request of one of the two sites or can be completely automated. The information exchanged can be intended or not intended to be used during the telephone call.

The information exchanged can advantageously comprise information concerning the second site S2 and/or the contents of the telephone call.

The exchanges of information can include information sent by the first site S1 to the third site S3 or by the third site S3 to the first.

In the particular example and by no means restricted to a correspondent belonging to the second site S2, contacted by a sales call centre agent belonging to the first site S1, the information exchanged can, for example, include information on the correspondent's civil status, his tastes, his occupation, etc., communicated by the third site S3, to the call centre agent. Such information proves to be very useful for sales purposes In this example, the information sent by the third to the first site S1 can also include questions which the call centre agent must ask the correspondent who he is calling. The information sent by the first site S1 to the third site S3 can include the answers which the correspondent has given to the questions and the decisions relating to the telephone call.

The integration operations can advantageously comprise the sending of information by fax, post or email, to the second site S2 and/or another remote site.

Thus, a telephone call can lead to the sending of information to a site remote from the first processing site S1. The method according to the invention advantageously makes it possible to process this transmitted information at a site other than the first site S1. This site can be the third site S3 to which a request was transmitted or any other site which is in communication with the first and/or the third site S3.

Thus, means of sending information can be gathered together in one site so as on the one hand to centralize the sending of information and on the other hand to offer the potential use of these means by a plurality of processing sites. This avoids on the one hand equipping all the telephone call processing sites with means of sending information such as, for example, fax equipment the cost of which is not insignificant, and on the other hand, carrying out this transmission, remotely without any geographic constraints. In fact in this way it is not necessary to be on a site for transmitting information to be able to carry out such a transmission. All that is necessary is to be connected to the third site S3 and to carry out requests for information to be sent. The method according to the invention thus offers the advantage of flexibility in the computerized processing of information relating to a telephone call, in the deployment of the various participants, and a reduction in the associated costs.

Moreover, the sending of information can equally well be carried out both to the correspondent site and to any other site insofar as the references necessary for sending the information are communicated.

Information relating to the sending of information, as well as the contents of the information sent and the identification information, can be communicated by the first site S1 (i.e., the processing site) and/or by the third site S3.

The method according to the invention can be implemented to carry out, advantageously, the computerized processing of information relating to a plurality of telephone calls, constituting a call campaign managed by a fourth site S4 and made within the first site S1 constituting a call centre.

The method according to the invention can be implemented to carry out a computerized processing of information relating to a plurality of telephone calls made or envisaged within at least one call centre constituting the first site (S1).

In fact, the method according to the invention makes it possible to manage a plurality of calls made within the first site S1. This is made possible by the introduction of information specific to a telephone call into the data of URL type. This information makes it possible to distinguish one telephone call from another. It comprises to some extent the identifier of the telephone call. Thus this information can make it possible to identify the telephone call in relation to the subject of the telephone call and/or to the parties to the telephone call and/or to all other information regarding the nature of the telephone call or the relationship of the telephone call to a particular group, and in particular to a call campaign.

The method according to the invention thus makes it possible advantageously to manage all or part of the telephone calls of a call centre or whole or part of the calls made within the framework of a call campaign.

In an advantageous but by no means limitative embodiment, such a call campaign can be proposed by a fourth site S4. This fourth site S4 can be an advertiser site which commissions a call campaign, using a certain number of prospective customers, to a call centre which can be the first site S1. The fourth site S4 provides information relating to the call campaign to the third site S3. Then the third site S3 allows, progressively, telephone calls which are part of the call campaign to provide the first site S1 with information relating to each prospective customer and each telephone call. At the same time, the third site S3 also carries out the computerized processing of information relating to the telephone calls as the telephone calls progress.

The method according to the invention comprises the sending by the third site (S3) to the first site (S1) of information regarding the setting up of at least one telephone call. In fact, the first site can make a request, to the third site, for a telephone call to be made. The third site can select according to various criteria a telephone call to be made and also all or a part of the information relating to this call. Information relating to this call is then transmitted to the first site which can make the telephone call while benefiting from a part or all of the advantages of the method according to the invention for the computerized processing of a telephone call. In this case, the third site does not take part in setting up the call and lets the first site dial the telephone number corresponding to the call to be made.

In a non-limitative example, the case of a unit operator can be considered who makes a request for a telephone call to be made to the third site S3. The site S3 selects a prospective customer according to various criteria. The site S3 communicates to the operator the telephone number of the prospective customer to be dialed. This number can, for example, be communicated on the computer screen of the operator. The operator dials the number appearing on the screen and then uses all the functions made available to them by the third site as if they were in a centre with ACD.

The method according to the invention can also be implemented in the case where the first site does not have ACD facilities.

Moreover, the method can, advantageously, comprise the downloading from the third site (S3) to the first site (S1) of a software tool designed to be able to set up at least one telephone call of Switched Telephone Network (STN) or Voice over Internet Protocol (VoIP) type.

This tool can be downloaded, in particular, at the request of the site S1 or be communicated automatically, for example, with a list of prospective customers to be called. In this case, this tool could be used to make a choice of a telephone call to be set up, in a similar way to a standard ACD. This call can be made via a Switched Telephone Network (STN) telephone line or in a mode using a computer network, in particular in Voice over Internet Protocol (VoIP) mode.

Similarly, the method according to the invention can advantageously be implemented to carry out the computerized processing of information relating to at least one telephone call made within a plurality of call centres.

In this case, the data of URL type generated will also comprise information relating to the call centre which processes the telephone call.

The advantage of such a computerized processing of information relating to the telephone calls of a plurality of call centres is the possibility of centralizing the means of data processing. The advantages of such a possibility have been mentioned above.

However, the centralizing of databases and the possibility of transferring workload between telephone call processing sites are also a direct advantage of such data processing. Thus, it is possible by carrying out such a centralized treatment, to effect workload transfers between the telephone call processing sites without the need to transfer data. In fact, according to the prior state of the art, a workload transfer of telephone calls, partly or entirely, between processing sites, requires that the data relating to the telephone calls forming part of the transferred workload are also transferred. The use of the method according to the invention, for example with a virtual CTI at the third site S3, advantageously makes it possible to store the data not at the first site S1, which is the processing site for the telephone call, but at the third site S3 or another site which is in communication with the third site S3. Thus, the workload transfers of calls from the first site S1 to a completely different site for processing telephone calls will not require the transfer of information concerning the call workload to this other call site. The computerized processing of information relating to the telephone calls forming part of the workload transferred to this other sit, can always be carried out by the third site S3, managing the virtual CTI by a simple connection from this other call site to the third site S3.

The computerized processing of information relating to a telephone call advantageously includes a recording, by the third site S3, of information concerning the progress of at least one telephone conversation.

Such a recording makes it possible establish the traceability of telephone calls.

Recorded information can include information on the content, the purpose, the date, the duration, the parties to the telephone call and the conclusions made relating to such a call. The telephone call can also be recorded in its entirety, by taking all the legal precautions.

Such a recording offers the possibility of retrieving information relating to any call later on. The recording of information also makes it possible to maintain a control over the telephone calls and thus to improve or manage the quality of the telephone calls.

It also makes it possible to carry out a statistical study of information concerning a plurality of telephone calls made within one or more call centres.

The statistical study can also be carried out with a recording of information concerning a plurality of calls. This advantageously makes it possible to have an overall picture of one or more call centres and to better control these call centres as regards performance and workload levels.

The statistical study can be made at the level of a call centre but also at the level of one of the parties to the telephone call and/or of the data processing operations carried out. Thus, details of the operations carried out relating to a call are available for more in-depth studies or for routine operations such as detailed billing A measure of the performances of a call centre, and/or a call centre agent can also be carried out.

Using the invention, a call campaign can advantageously be processed by a plurality of call centres. Thus, it is possible to transfer one part of a call campaign to one call centre and another part to another call centre and so on.

As the computerized processing of information concerning the telephone calls within the framework of the call campaign is carried out by the third site S3, this limits additional constraints. The exchanges of information concerning a telephone call are carried out between the call centre which processes the call and the third site S3 independently of these other call centres. Each call centre carries out its workload and everything is centralized progressively by the third site S3.

It is possible to distribute a workload between several call centres in order to carry out a campaign as quickly as possible. It is also possible to balance the workload between call centres.

The method can advantageously include, moreover, a consultation or a modification, in real time, of information relating to at least one telephone call made or envisaged. Thus, supervision or monitoring in real time of the telephone calls is possible. For example, one or a plurality of calls to be made can be consulted, modified or stopped by a simple operation.

Moreover, at least one telephone call is made on behalf of a fourth site (S4), the method according to the invention including moreover an exchange, between the third site (S3) and said fourth site, of information relating to said telephone call and/or to at least one call centre.

This exchanged information can be of all types and can comprise statistical studies concerning one or more call centres. It can also comprise statistical studies concerning the people forming part of one or more call centres. These statistical studies can be performance studies. Exchanged information can also be information on the status of one or more call centres such as information concerning workload, tariffs, etc. All this information offers the fourth site S4 the possibility of making a choice of call centre for the call campaign to be carried out, with full knowledge of the facts and according to its own criteria.

This exchanged information can also be information relating to one or more telephone calls. The fourth site S4 can thus have access in real time to information concerning the call campaign which it manages. It can thus better manage its call campaign, carry out workload transfers, have an outline of the results of its call campaign, change the parameters of its call campaign etc. It therefore has total control over the call campaign which it is managing.

The method according to the invention can advantageously be used to build a marketplace of calls, consisting of one or more calls campaigns managed by the fourth site S4, and intended to be processed by one or a plurality of call centres.

The fourth site S4, which, in a non-limitative example of the application of the method according to the invention, is composed of several campaign advertisers, places one or more campaigns on a server of the third site S3. The first site S1 termed processing, composed of one or a plurality of unspecified call centres, is connected to the third site S3. It is registered for a campaign and starts to process the telephone calls within the framework of the campaign to which it was registered.

It may also be that it is the fourth site S4 which makes the choice of one or more call centres to process the call campaign which it places in the marketplace of calls.

The registration requires certain information and it is validated only on authorization by the third site S3 and/or the fourth site S4, In order to be able to make telephone calls, the first site S1 must follow the steps indicated by the third site S3. The installation of the method according to the invention can, advantageously, be carried out remotely, using a computerized communication of Internet type or any other type allowing the exchanges of information relating to the installation of the method according to the invention.

According to another aspect of the invention, a system of computerized processing of information is proposed relating to a telephone call between a first site S1 termed processing and a second site S2 termed correspondent, comprising:
means for generating data of URL type, starting from information dependent on said telephone call,
means for transmitting, from said first site S1 over a computerized network to a third site S3, a request dependant on the URL generated, and
means for triggering and carrying out operations termed integration, comprising at least means for processing the data dependent on the transmitted request.

The third site S3 comprises the means for receiving a request of URL type and the means for triggering operations termed integrations starting from the reception of the request of URL type.

The means for generating data of URL type comprise means of ACD (Automatic Call Distribution) and/or PABX type, and/or computing type. Thus, the generation of data of URL type can be made by an ACD or a PABX if the first site S1 is equipped with an ACD or a PABX. This generation is done using software which will be loaded in the ACD or the PABX. If the first site S1 has a CTI, it will be deactivated at the time of the use of the virtual CTI which is at the third site S3.

The generation of data of URL type can also be carried out by an item of equipment of computer type.

The system comprises the means for transmitting the request. These means can be computing means such as an Internet browser, or means such as an ACD or a PABX.

The means for processing data comprise means for sending information in the form of fax, post or email. These means can be located on the third site S3 or another site connected to the third site S3.

The third site S3 comprises the means for receiving a request of URL type and means which allow, starting from the reception of the request of URL type, to start operations termed integrations.

Other advantages and characteristics will become apparent on examination of the detailed description of an embodiment which is by no means limitative, and of the attached drawings in which:

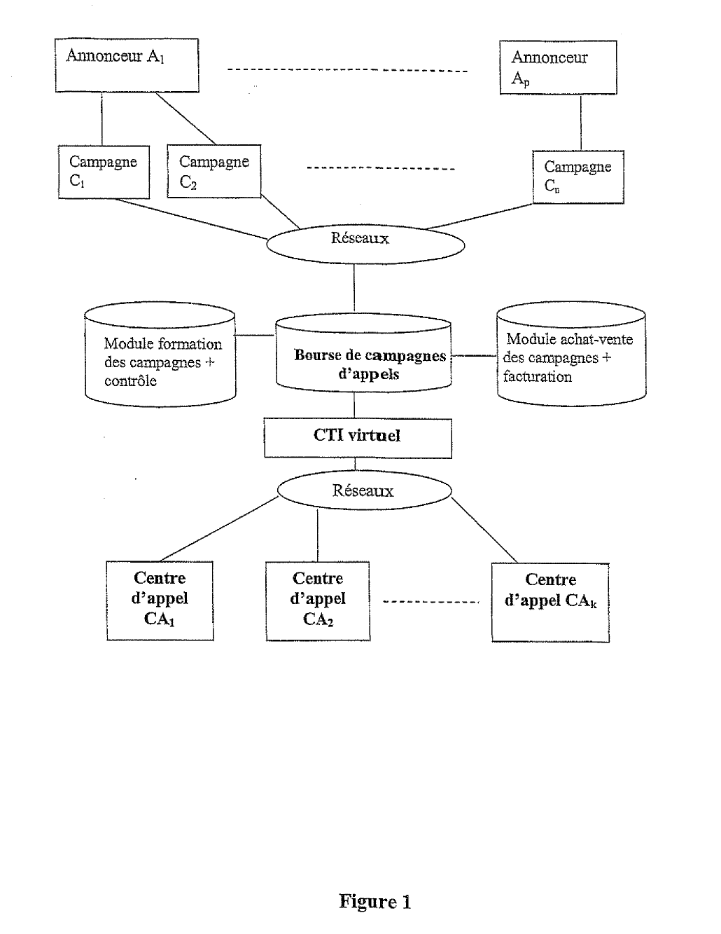

FIG. 1 describes an example of a call campaign marketplace according to the invention;

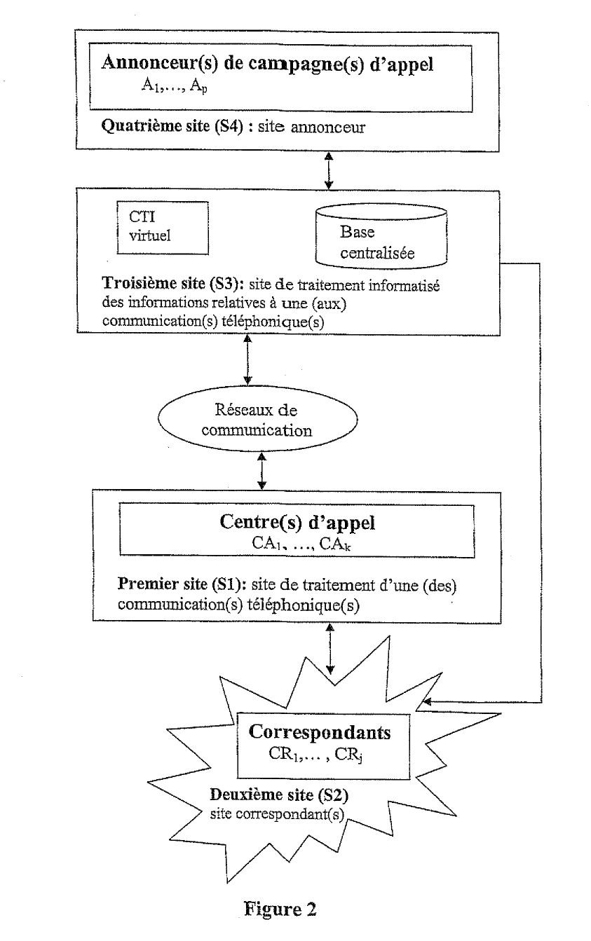

FIG. 2 shows an example of a computerized system for processing the data relating to a telephone call according to the invention; and

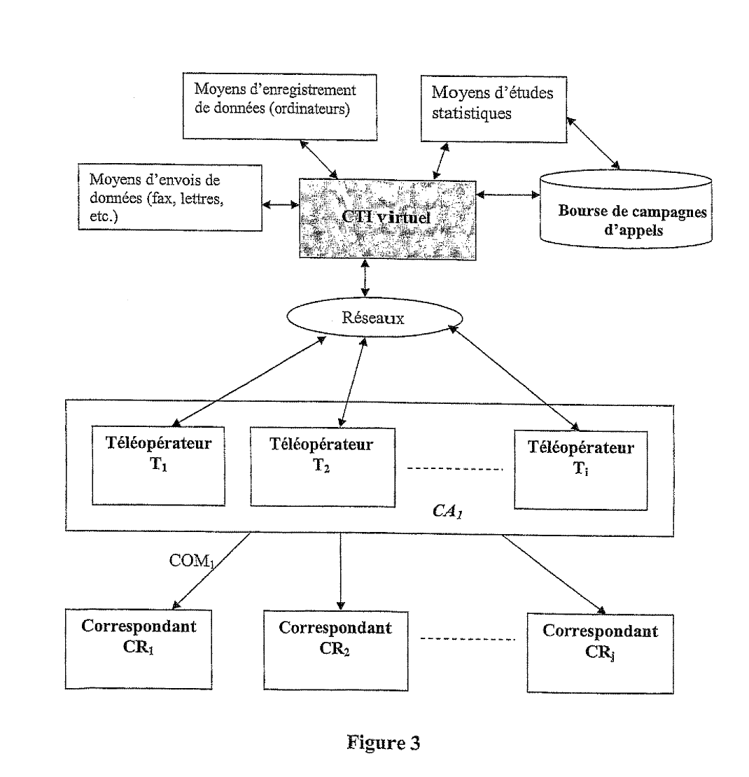

FIG. 3 represents an example of a diagram of the computerized processing of information relating to the telephone calls of a call centre, in accordance with the method according to the invention.

A specific embodiment which is by no means limitative relates, with reference to FIG. 1, to a call campaign marketplace. A set of call centres which will be called CC in which one can find the call centres CC₁, CC₂, . . . and CCₖ processes a set of call campaigns C in which the call campaigns C₁, C₂, . . . and Cₖ are found.

The call campaigns are placed on the marketplace of calls by advertisers of call campaigns, as described in FIG. 2. The marketplace of calls is managed by the third site S3 termed site for the computerized processing of the information relating to telephone calls. The call campaigns placed on the marketplace of calls are stored at the third site S3. The call centres, each comprising an instance of the first site S1, termed site for processing telephone calls, are connected to the third site S3 by a communications network, for example of Internet type. The campaigns are processed by the call centres in several possible ways. The first is that the call centres are connected to the third site S3 and decide to process a campaign which is present in the marketplace of calls. A second possibility is that the advertisers of campaigns decide themselves on the call centres which will process the call campaigns.

Advertiser A₁ places a call campaign C₁ which will be processed by the call centres CC₁ and CC₂. The call centres CC₁ and CC₂ thus start to make telephone calls within the framework of the C₁ campaign. The advertisers can be connected to the marketplace of calls via a network connection of any type.

The call centre comprises a first training module for the campaigns and control of this training, and a second module for the purchase-sale of the call campaigns and billing.

Let us take the case of the centre CC₁ processing its telephone call workload within the framework of the C₁ campaign. With each call, a URL specific to this call is generated. In this URL there is data to specify that this call is made within the framework of the C₁ campaign and that it is made by the call centre CC₁, as well as data concerning the correspondent CR₁ and call centre agent T₁.

Once the URL is generated, it is communicated to the third site S3, hosting the virtual CTI. On reception of the URL transmitted by the call centre, the virtual CTI decodes this URL and retrieves the data necessary to distinguish that this URL has been generated by the call centre CC₁, for the call COM₁, made by the call centre agent T₁, within the framework of call campaign C₁ with the correspondent CR₁. The virtual CTI communicates information concerning the campaign C₁ and the correspondent CR₁ to the call centre CC₁ at the same time as the call COM₁ is established. Thus when the call COM₁ is established, the information concerning call COM₁, namely the information concerning the call campaign C₁ and the correspondent CR₁, is made available to call centre agent T₁ of the call centre CR₁. During the entire duration of the call, the operations of exchanges of information continue according to the same method. A URL is constructed and transmitted at each step of the call for each data processing operation. Throughout the call, there is in parallel a recording of data relating to the telephone call at the third site S3, including information originating from the contents of the call as well as of data regarding the nature of the call. Information relating to the contents of the call comprises inter alia, information concerning the campaign, namely the questions and answers given to these questions, data about the operations carried out such as the sending of faxes, emails, or documentation and the decisions taken in connection with the call, such as for example the organization of appointments or subsequent calls. The data relating to the nature of the call can be for example data relating to the history of a call COM₁. A voice recording of the entire call is also possible.

The data relating to the contents of the call make it possible to retrieve the contents of the call at a later date. They also make it possible, in combination with the data relating to the nature of the call, to participate in a statistical study concerning the calls processed by the call centre agent T₁, with the purpose, for example, of rating the performances of the call centre agent. This recorded data can also be also used to carry out statistical studies relating to the call centre C₁ or even a statistical study relating to the campaign. Other statistical studies are possible and can be used for more in-depth studies or comparative studies between CC₁ and CC₂.

Thus, the third site S3 and/or the integration site (if the integration site is not the third site S3 are able, at any time, to present information concerning the call campaign C₁ to the advertiser A₁ and to retrieve any information relating to the processing of the calls concerning the campaign C₁.

Using the virtual CTI, with reference to FIG. 3, the third site S3 can send data in fax, postal or electronic form. These actions can be decided before, during, or after the call COM₁. They will be processed directly by the third site S3 which has the means to carry out such transmissions. These transmissions can be made to the correspondent CR₁ or any other site insofar as the information is sent to the third site S3.

The third site S3 can carry out a complete trace of each call which has passed through each call centre, within the framework of each call campaign, and carry out multiple and varied studies depending on the request.

Of course, the invention is not limited to the application which has just been described. It could be applied to calls made in any field, whether in the public, private or military field.

1.-22. (canceled)

23. Method for the processing of a group of a plurality of telephone calls comprising, at least partly, one call campaign to be processed by at least one or more second sites (S2), said method comprising the following steps:
transmission, from at least a fourth site (S4) to a third site (S3), of information representing the parameters of said campaign, said third site (S3) being connected to a plurality of sites (S1) for the processing of telephone calls;
transmission of said campaign parameters from the third site (S3) to at least one processing site (S1) among said plurality of processing sites, having to process the telephone calls of said campaign;
processing the telephone calls of said campaign by said selected processing site (S1).

24. Method according to claim 23, characterized in that the processing site (S1) having to process the telephone calls is selected by the fourth site according to information relating to said plurality of processing sites.

25. Method according to claim 23, characterized in that the processing site (S1) having to process the telephone calls selects said telephone calls according to the parameters of the campaign.

26. Method according to claim 23, characterized in that the processing site (S1) having to process the telephone calls is selected by the third site (S3) according to information relating to the plurality of processing sites and/or the parameters of the campaign.

27. Method according to claim 23, characterized in that the third site (S3) is a site which is remote compared with the processing site having to process the telephone calls.

28. Method according to claim 23, characterized in that the processing of a telephone call among the plurality of telephone calls comprises a computerized processing of information relating to said telephone call between the processing site (S1) and the second site (S2), said computerized processing comprising:
on the one hand,
a generation of an item of data of URL type starting from information dependent on said telephone call; and
on the other hand, at least one iteration of the following steps:
transmission, from the said first site (S1) through a computer network to a third site (S3), of a request dependant on the data generated, and
on reception of this request, triggering and implementing operations termed integration, comprising at least one data processing dependant on the transmitted request.

29. Method according to claim 28, characterized in that the triggering and/or implementing of the integration operations is carried out by the third site (S3).

30. Method according to any one of claim 28, characterized in that the integration operations comprise an information exchange between the processing site (S3) and the third site (S3).

31. Method according to claim 30, characterized in that the exchanged information comprises information concerning the second site (S2) and/or the contents of the telephone call.

32. Method according to any one of claim 28, characterized in that the integration operations comprise the sending of information in fax, postal or electronic form to the second site (S2) and/or to another remote site.

33. Method according to any one of claim 28, characterized in that it comprises the sending by the third (S3) to the first site (S1) of information relating to setting up at least one telephone call.

34. Method according to claim 28, characterized in that it comprises, in addition, a downloading from the third site (S3) to the processing site (S1) of a software tool designed to carry out the setting up of at least one telephone call of Switched Telephone Network (STN) or Voice over IP (Internet Protocol) type.

35. Method according to claim 28, characterized in that it comprises a recording, by the third site (S3), of information concerning the progress of at least one telephone call.

36. Method according to claim 35, characterized in that recorded information is used in a statistical study of information relating to at least one telephone call.

37. Method according to claim 28, characterized in that it comprises in addition a consultation or a modification, in real time, of the information relating to at least one telephone call which has been made or prepared.

38. Method according to claim 23, characterized in that it comprises in addition an exchange, between the third site (S3) and the fourth site (S4), of information relating to the said telephone call and/or to at least one call centre and/or the campaign.

39. Method according to claim 23, characterized in that it is implemented in order to create a marketplace of calls consisting of a call campaign carried out on behalf of the fourth site (S4), and intended to be processed by several processing sites.

40. System for processing a group of a plurality of telephone calls comprising at least partly a call campaign to be carried out by at least one or more second sites (S2), said system comprising the following steps:
a. means of transmission, from at least a fourth site (S4) to a third site (S3), of information representing said campaign parameters, said third site (S3) being connected to a plurality of sites (S1) for processing telephone calls through a communication network;
b. means of transmission of said campaign parameters from the third site (S3) to at least one processing site (31) among said plurality of processing sites having to process the telephone calls of said campaign;
c. means of processing the telephone calls of said campaign by said selected processing site (S1).

41. System according to claim 40, characterized in that call the processing means comprise means for the computerized processing of information relating to a telephone call between the processing site (S1) and the second site (S2), these means comprising:
d. means of generation of an item of data of URL type, using information dependent on the said telephone call; and
e. means of transmission, from the said processing site (S1) through a computerized network to a third site (S3), of a request dependant on the URL generated, and
f. means of triggering and implementing operations termed integration, comprising at least one data processing dependant on the transmitted request.

42. System according to claim 41, characterized in that the means of generating an item of data of URL type are comprised in the ACD (Automatic Call Distribution) type mean.
